(19) United States
(12) Patent Application Publication
(10) Pub. No.: US 2012/0144938 A1
(43) Pub. Date: Jun. 14, 2012

(54) INSPECTION DEVICE AND METHOD

(76) Inventors: Katsuyasu Inagaki, Hitachinaka (JP); Kenji Aiko, Ninomiya (JP); Masaru Kamada, Fukaya (JP); Toshiro Kubo, Hitachinaka (JP); Yusuke Miyazaki, Hitachinaka (JP)

(21) Appl. No.: 13/390,973

(22) PCT Filed: Sep. 6, 2010
(86) PCT No.: PCT/JP2010/005448

§ 371 Date: Feb. 17, 2012

(30) Foreign Application Priority Data
Sep. 30, 2009 (JP) 2009-225875

(51) Int. Cl. G01N 1/34

(52) U.S. Cl. 73/865.8

(57) ABSTRACT

Inspection units have moving parts such as XY-movement stage mechanisms and high-speed rotation mechanisms for inspecting the entire surfaces of substrates, and it is difficult for fan filter units (FFUs) to completely remove all foreign materials. The provided inspection device has: a fan filter unit divided into a plurality of regions; an exhaust unit, divided into a plurality of regions, for getting rid of air from the fan filter unit; and a transfer system disposed between the fan filter unit and the exhaust unit. The chief characteristic of the provided inspection device is that the flow rate in some of the regions of the fan filter unit and the flow rate in some of the regions of the exhaust unit are controlled in accordance with the operations of the transfer system.

### TECHNICAL FIELD

The present invention relates to an inspection device and a method, and for example, relates to an inspection device used for inspecting substrates which are inspected objects such as magnetic disks, semiconductor wafers or the like, in super cleanliness spaces.

### BACKGROUND ART

In manufacturing lines of semiconductor substrates, thin film substrates or the like, dust emission conditions of manufacturing devices are monitored and existences of foreign bodies, scratches, and other defects on wafers to be products are inspected. In particular, recently, due to higher densities of semiconductor circuit patterns, it is necessary to detect microscopic foreign bodies or defects in dozens of nanometers or the less, accordingly, it is required that the environments for inspecting substrates locally realize cleanliness spaces and that the foreign bodies adhered to the substrates are to be unlimitedly as close to zero as possible.

With regard to these requirements, various improvement examples have been reported.

For example, for observing substrates with laser scanning microscopes, by taking in air currents flowing from an upper part to a lower part into an interior of a casing and exhausting, it is possible to eliminate dust emissions from stages comprising an XY-axis movement mechanism (PATENT LITERATURE 1).

Moreover, for keeping environments to inspect semiconductor wafers or the like in high degrees of the cleanliness and for appropriately inspecting fine patterns, the clean air is supplied into an interior of a clean box enclosing a stage for inspection or the like where semiconductor wafers are installed, the clean air is guided onto the stage for inspection with a protrusion part provided in a lower end of the stage for inspection (PATENT LITERATURE 2).

Furthermore, in a configuration where a system is surrounded by a case; a substrate is disposed on a part of subdivided parts; and an inspection stage capable of moving in XY directions is installed, air currents are guided onto the wafers by a plurality of air guiding panels so that an air sucked from an upper part is led above a wafer in parallel (PATENT LITERATURE 3).

### PRIOR ART REFERENCES

### Patent Literatures

[PATENT LITERATURE 1] JP 07-230037 A

[PATENT LITERATURE 2] JP 2001-118896 A

[PATENT LITERATURE 3] JP 2005-140778A

### SUMMARY OF THE INVENTION

### Problems to be Solved by the Invention

As shown in the aforementioned conventional techniques, in inspection devices for semiconductor wafers, magnetic disks or the like, due to the super-finer pattern line widths or the higher densities, a minimum detection performance for foreign bodies or defects in dozens of nanometers or the less on substrate surfaces is required.

These detection units need to have foreign bodies adhered to substrate surfaces unlimitedly as close to zero as possible. However, in the inspection units, there are moving parts such as XY movement stage mechanisms, high speed rotation mechanisms or the like for inspecting whole surfaces of the substrates, and it is difficult also for fan filter units (hereinafter, FFU) to have adhered foreign bodies being zero.

In the aforementioned conventional techniques, by generating air currents in a vicinity of the XY stage movement mechanism, foreign bodies adhered to the substrate surfaces are suppressed. However, for example, in the case that there are moving parts to move substrates such as Φ300 mm semiconductor wafers or the like while rotating in a high speed and to inspect the whole surfaces, considerations are not made regarding a point that the air currents are disturbed by Ekman's spiral vortex flow or Karman's vortex flow or the like caused in the substrate vicinities by the high speed rotation.

There have been problems caused by this phenomenon that, in vicinities of wafer chucks for holding substrates which rotate in high speeds or the substrates, the foreign bodies are whirled up from moving parts by the disturbance of air currents due to Ekman's spiral vortex flow or Karman's vortex flow, and several to dozens of foreign bodies are adhered in the substrate vicinities or the like.

In the aforementioned conventional techniques, super cleanliness spaces are realized by using FFUs or exhaust mechanisms, however, the control method is achieved in the constant condition (hereinafter, static control), then it is not always deemed to be the optimal condition for the wafer chuck movement, XY stage movements or layout conditions of structures, and it is hard to mention that enough super cleanliness spaces are realized.

Therefore, an object of the present invention is to provide a means, in respect of the condition, not to adhere foreign bodies onto substrate surfaces, even there are high speed rotations and motions of movement mechanisms in super cleanliness spaces.

### Means to Solve the Problem

A first feature of the present invention is to comprise a fan filter unit divided into a plurality of domains, an exhaust unit divided into a plurality of domains for exhausting air from the fan filter unit, and a transfer system disposed between the fan filter unit and the exhaust unit, and to control, depending on the movement of the transfer system, a flow amount of a partial domain of the fan filter unit and a flow amount of a partial domain of the exhaust unit.

A second feature of the present invention is to comprise a wind speed sensor, wherein the fan filter unit and the exhaust unit vary the flow amount, depending on information from the wind speed sensor.

A third feature of the present invention is that the wind speed sensor is disposed at least in either one of the delivery position of the inspected object in the transfer system, or the inspection position.

A fourth feature of the present invention is to comprise a louver at least in either one of the backward part of the fan filter or the forward part of the exhaust unit.

A fifth feature of the present invention is to comprise a control unit capable of controlling clean gas supply air volume, supply position control, exhaust air volume, and exhaust position, in accordance with the motion sequence of the device.

### Effect of the Invention

According to an air current control means of the present invention, it becomes possible to improve the level and the stability of the cleaning and to perform inspection in high reliability.

### BRIEF DESCRIPTION OF THE DRAWINGS

FIG. 1 is a schematic diagram of an inspection device with regard to one embodiment of the present invention;

FIG. 2 is a structure drawing showing details of one embodiment of the present invention;

FIG. 3 is a list showing motion sequences of one embodiment of the present invention;

FIG. 4 is a drawing showing a motion sequence list and each movement point of one embodiment of the present invention;

FIG. 5 is a drawing showing effects of the louver movement of one embodiment of the present invention;

FIG. 6 is a drawing showing a difference between the dynamic control and the static control based on air current simulation in a TP position of one embodiment of the present invention; and

FIG. 7 is a drawing showing a difference between the dynamic control and the static control at velocities per position of one embodiment of the present invention.

### MODES FOR CARRYING OUT THE INVENTION

Hereinafter, an explanation is made with reference to the drawings.

### Embodiment 1

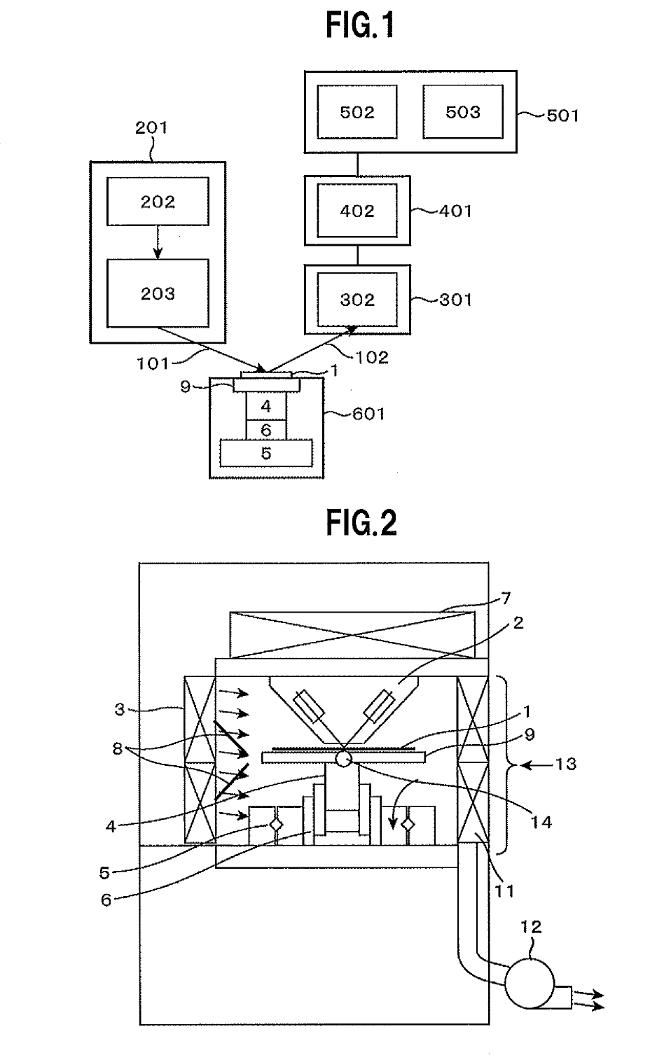

First, with reference to FIG. 1, an outline of an inspection device and a method according to the present invention will be explained.

The inspection device comprises a transfer system 601 for mounting and moving a sample 1 (including substrates such as wafers or the like), an irradiation optical system 201 for irradiating a light 101 on the substrates, a detection optical system 301 for detecting a light 102 (scattered light, reflection light or the like) from the sample, an inspection processing system 401 for inspecting the sample from the detection result, and an input/output system 501 for displaying and inputting various kinds of information.

More specifically, the transfer system 601 includes a wafer chuck 9 for mounting the substrates, a horizontal direction movement mechanism 5 and a vertical direction movement mechanism 6 for equipping and moving the wafer chuck 9, and a high speed rotation mechanism 4. The irradiation optical system 201 includes a light source 202 for generating a light, and an optical element 203 disposed between the substrate and the light source 202 for guiding the light to the substrate. The detection optical system 301 includes a light detector 302 for detecting the light from the sample however it may include the optical element disposed between the substrate and the light detector 302 for guiding the light from the substrate to the light detector. The inspection processing system 401 comprises a defect processing unit 402 for inspecting sample defects from the detection result of the light detector. The input/output system 501 includes a display unit 502 for displaying inspection results or defect information and an input unit 503 for inputting inspection conditions or the like.

Details are explained by FIG. 2.

This embodiment is an optical inspection device for inspecting the whole surface of the semiconductor wafers with high accuracy.

This optical inspection device comprises a detection unit 13 for accommodating a configuration mechanism including an optical system 2 for inspecting an inspected object wafer (hereinafter, wafer) 1, a high speed rotation mechanism 4 to inspect the whole surface of the inspected object wafer 1, a horizontal direction movement mechanism 5 to move radially and a vertical direction movement mechanism 6 to move vertically, and FFUs (Fan Filter Unit) 3 and 7 divided into four for supplying clean air to the interior of this detection unit 13. The FFU 3 laterally supplies clean air and the FFU 7 supplies clean air from the upper part of the detection unit. In front of the FFU 3, a louver 8 which is capable of controlling the air volume and the wind speed of the clean air is installed. The clean air taken into the detection unit 13 by the FFUs 3, 7 is exhausted to the exterior of the detection unit 13 by an exhaust unit 11 divided into four and a central exhaust mechanism 12.

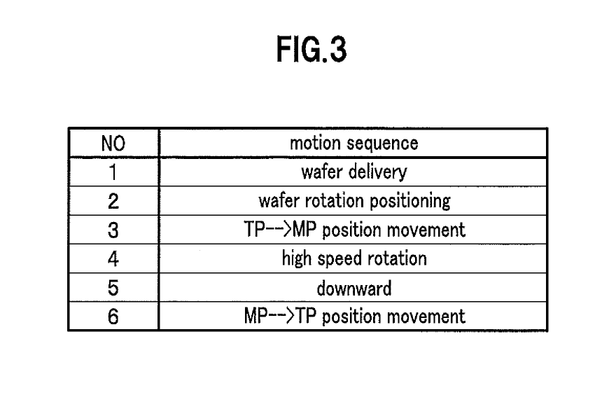

In the case to inspect the wafer 1, it is possible to divide into motion sequences shown in FIG. 3, i.e.,

a wafer delivery movement from transfer devices such as mini-environments or the like (No. 1), a wafer rotation positioning (No. 2), a movement from a delivery position (TP position) to an inspection position (MP position) (No. 3), a high speed rotation when performing inspection (No. 4), a wafer chuck 9 downward (No. 5), and a movement from the inspection position (MP position) to the delivery position (TP position) (No. 6).

Various air currents caused by these motion sequences become factors of foreign bodies adhered onto the wafer 1, and in some cases, it has been difficult to maintain the high degrees of the cleanliness in the conventional static air current control.

Moreover, in the detection unit 13, there are structures such as the high speed rotation mechanism 4, the horizontal movement mechanism 5, the vertical direction movement mechanism 6 necessary for the inspection or the like, and in some cases where these structures have been obstacles, the clean air from the FFU 3 has caused air current turbulences and adhered foreign bodies onto the wafer 1.

In order to solve this, suppressing the occurrence of air current turbulences by the motion sequences or the structures and performing the air current control (dynamic control) in consideration for each sequence or the layout of the structures are effective methods.

The air current dynamic control of this method is a method to dispose the wind speed sensor 14 in the vicinity of the wafer 1 (TP, MP positions) in order to maintain the high degrees of the cleanliness in the detection unit 13, and to feedback-control by the information to the FFUs 3, 7, the louver 8, and the exhaust unit 11.

The control is performed depending on the horizontal movements, vertical, rotation movements of the stage and motion positions of the mechanisms, accordingly, it is possible to suppress air current turbulences of the factor to adhere foreign bodies onto the wafer 1.

Moreover, in the wind speed sensor 14, threshold values or setting ranges for judging whether the wind speed is appropriate are provided, and conditions in the supply side and the exhaust side are adjusted so that the values can be appropriate values. In the case of being out of the setting values, it is possible to give an alert as an alarm, otherwise to stop the sequence and to stay in a stand-by condition until the sensor output becomes an appropriate value.

In addition, as an advantage of the air current dynamic control, energy conservation effects can be mentioned. In the conventional static control, regardless of the existence of the inspection of the wafer 1, the air volume control being constant all the time is performed, however in this method, the control is performed depending on the motion, accordingly the power consumption can be reduced by suppressing the air volume during the stand-by or the like. Also in components such as FFU, air supply, exhaust components or the like, the excessive component specifications over the appropriate values which are originally necessary are not required, and it becomes possible to use appropriate components.

Moreover, because the condition of the air current can be optimized, it is possible to improve the degrees of the cleanliness. Also, because the flow formation time of the air current can be shortened, it is possible to reduce the time loss for the throughput.

Furthermore, in the conventional static control, it is possible to reduce the wasteful space to secure the air currents which have been necessary to suppress the rising, whirling-up air currents or the like, and it is also possible to reduce the entire size of the device. In this case, the resource conservation and the energy conservation by down-sizing the utilized equipment can be expected.

In addition, in the future, it is predicted that the diameter up-sizing of the wafers and the higher speed are essential as requirements for the inspection devices, however, by the air current dynamic control according to the present invention, it is possible to control the air currents to satisfy each condition in the motions of the high speed rotation and the movement mechanism, therefore it is possible to correspond, even if the moving parts conditions such as the diameter up-sizing of the wafers and the higher speed of the inspection time or the like are changed.

A concrete example of the delivery movement of the wafer 1 is shown below.

Generally, the wafer 1 is transferred from the exterior of the detection unit 13 to the interior of the detection unit 13 by the transfer equipment such as the transfer device. At the time, in the TP position which is a delivery position of the wafer 1, the following phenomenon is caused by the delivery movement of the wafer 1.

In order to deliver the wafer 1 carried from the transfer device, the wafer chuck 9 moves vertically and holds the wafer 1. Thereafter, the wafer chuck 9 performs the rotation movement for positioning.

A factor to give an influence to the degrees of the cleanliness on the wafer 1 is the air current whirling-up caused in the case that the wafer chuck 9 performs the vertical movement operation by the vertical direction movement mechanism 6. As the wafer chuck 9 moves vertically in a high speed, the air between the wafer 1 and the wafer chuck 9 is flowed out of the vicinity of the wafer chuck 9, and the phenomenon to whirl up microscopic foreign bodies on the wafer chuck 9 or in its vicinities, is caused. The whirled up foreign bodies are easily to be adhered onto the wafer 1 due to the rotation movement of the wafer chuck 9.

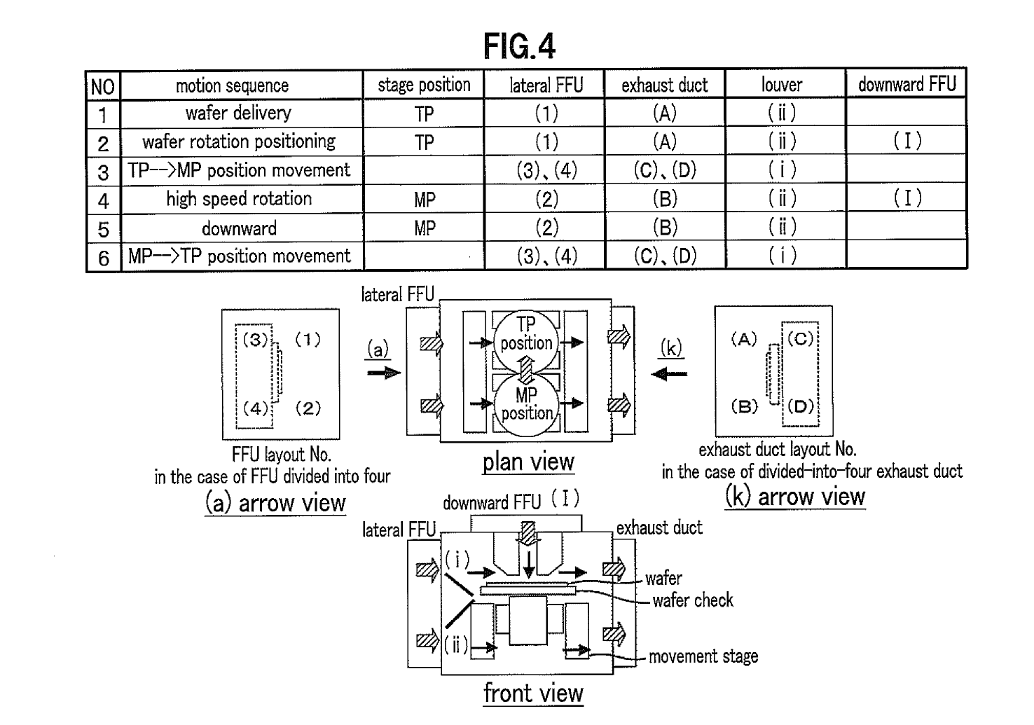

Therefore, in the present invention, as shown in FIG. 4, the air currents in the TP position are optimized, and in addition, the air current control in each motion sequence has been set in the following condition.

The FFU 3 has a structure divided into four and is capable of individually controlling depending on the number of the rotation. Moreover, the exhaust unit 11 also has a structure divided into four as well and has a method capable of controlling each.

In the FFU 3, by operating only a fan which is close to the wafer 1 ((1)) in the TP position, the whirling-ups caused by the obstacles such as structures or the like in the case that the other fan is operated and the like are decayed. In the case that there are structures such as mechanisms or the like, the air from the FFU 3 sometimes makes the air flows to the direction for moving away from the structures, and sometimes makes the flows to the un-intended direction, such as the occurrence of the rising air currents into narrow spaces with an accelerated flow velocity. In order to prevent them, the flow amount is set to suppress the air currents in the positions except for the required positions to suppress the air current turbulences. In the TP position, the flow amount of the FFU 3 in the TP position side is positively increased.

Moreover, by operating only the (A) of the exhaust unit 11 divided into four opposite to the ((1)) of the FFU 3 divided into four, the laminar flow is generated on the wafer 1. The louver 8 is set in the position (ii), and the flow-rectifying effect is further increased by controlling the direction of the air currents.

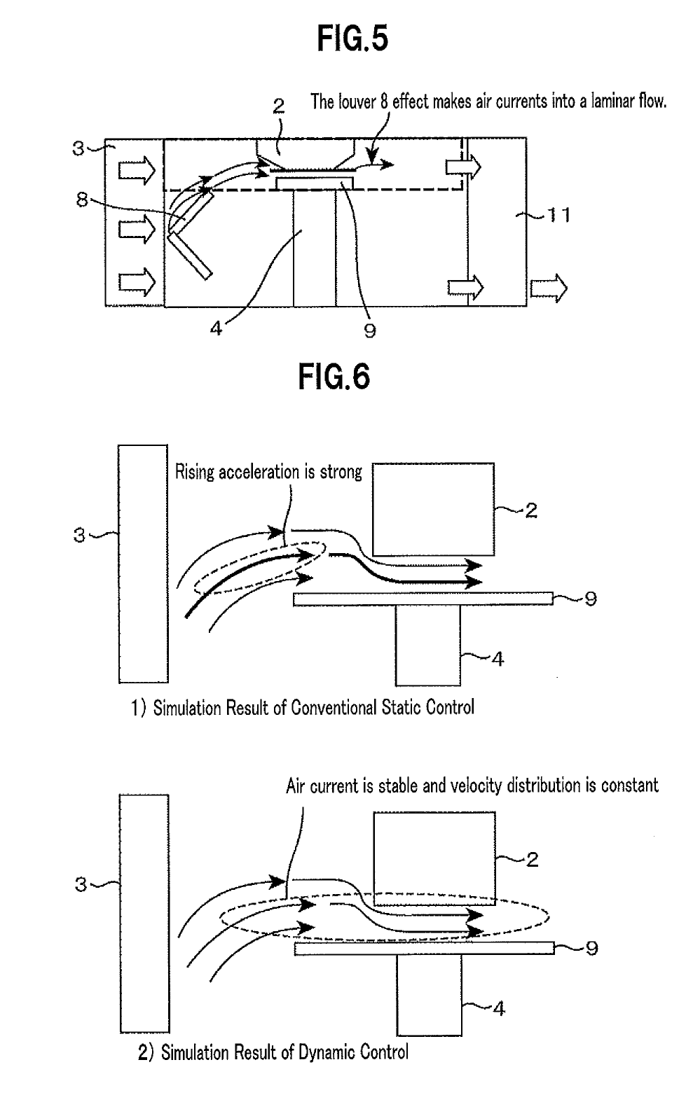

FIG. 5 is a simulation to have confirmed the effect of the louver 8, and it can be confirmed that the laminar flow is made on the wafer 1 by the louver 8 effect.

Moreover, by additionally moving the upper part FFU 7 at a time of the wafer rotation positioning and supplying the clean air onto the wafer 1, the vortex flow caused when rotating can be reduced. By doing this way, the air current on the wafer 1 in the TP position becomes a laminar flow, and the air current by the whirling-up and the vortex flow can be decayed.

When the wafer rotation positioning is completed in the TP position, the wafer chuck 9 with the wafer 1 thereon, in order to perform the inspection operation, horizontally moves to the MP position where the optical system 2 is disposed, by the horizontal direction movement mechanism 5. Since the horizontal direction movement mechanism 5 is disposed in the lower sides of the wafer chuck 9 and the vertical direction movement mechanism 6, the motion of the horizontal direction movement mechanism 5 results in the occurrence of the rising air current from the lower part in the inspection chamber. Regarding this sequence, by operating the lower part of the FFU 3 and the lower part of the exhaust unit 11, the rising air current to the wafer chuck 9 side is suppressed. The louver 8 is set in the condition (i) in order to increase the allocation of the air current to the lower side in the inspection chamber. By doing this way, more clean air comes into the condition close to the laminar flow in the lower side in the inspection chamber, and the rising air current is decayed.

Since the sequence to move from the MP position to the TP position after the inspection is completed is the same, the air current control becomes the same as this control.

The wafer chuck 9 which has horizontally moved from the TP position by the horizontal direction movement mechanism 5 performs the inspection operation in the MP position. The inspection operation inspects the whole surface while rotating the wafer chuck 9 in a high speed by the high speed rotation mechanism 4. By the high speed rotation, the disturbance of the air current by Ekman's spiral vortex flow, or Karman's vortex flow or the like caused in the substrate vicinity occurs.

In this sequence, the FFU 3 drives the MP position side, and the exhaust unit 11 also operates the MP position side.

Moreover, in order to generate a laminar flow on the wafer 1 more positively, the louver 8 is set into the position (ii). In addition, in order to reduce the influence of the vortex flow by the high speed rotation, the upper part FFU 7 is operated. By this way, foreign bodies adhered to the wafer 1 vicinity can be reduced.

In FIG. 6, an air current simulation result in the TP position before and after the dynamic control of the air current is shown. In the condition before the dynamic control, the condition for supplying and exhausting the air is not appropriate, therefore the air current condition from the FFU 3 outlet port to the wafer chuck 9 inlet port is not met, and the higher rising acceleration of the flow velocity results in the disturbance of the air current. The disturbance of the air current leads to the deterioration of the cleanliness condition and becomes an instability factor of the degrees of the cleanliness.

To the contrary, in the result after the dynamic control, the amount condition for supplying and exhausting the air is adapted (in a well-balanced manner). The air current flow is uniform, and places having locally fast air currents and positions forming air pools have disappeared. Moreover, it is possible to confirm that the time variation of the air current is a little and that the behavior of the air current is stable.

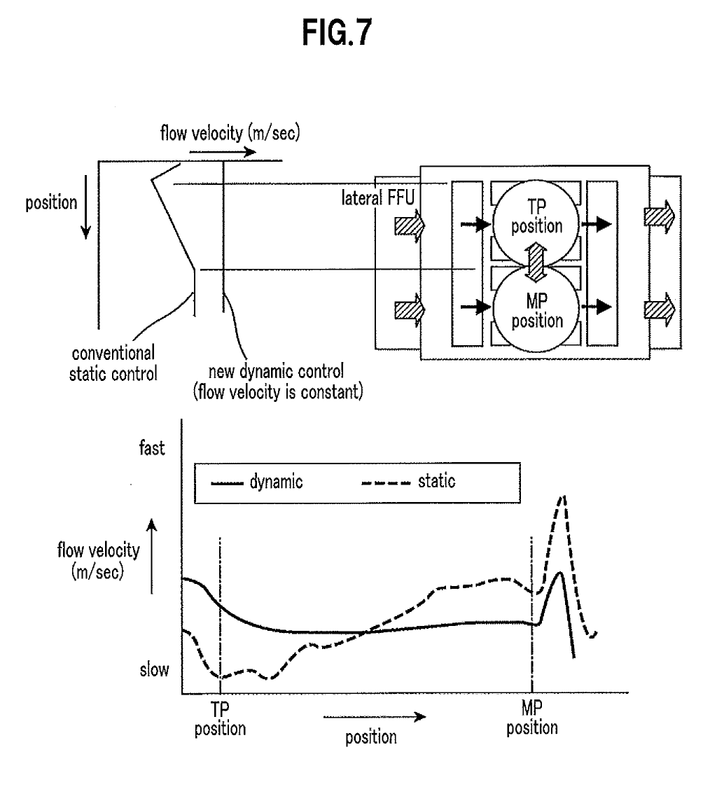

FIG. 7 shows a difference of the wind speed distribution between the dynamic control and the conventional static control.

This drawing simulates the distribution of the wind speed in each position in the case that the wafer chuck 9 is in the TP position, and in the conventional static control, due to the mechanisms and the structures in the inspection chamber, the dispersion of the wind speed occurs depending on the position. Especially, it can be understood that the wind speed is dropped in the TP position where the wafer chuck 9 mechanism exists. To the contrary, in the dynamic control, the distribution is uniform compared to the static control, and the improvement tendency is shown.

As above, by changing the air current control from the conventional static control to the dynamic control according to the present invention, it is possible to stabilize the air current and becomes possible to improve the cleanliness environment. Furthermore, as the flow formation time of the air current can be shortened, the time loss to the throughput can be reduced. Moreover, it becomes possible to supply and to exhaust the appropriate air per sequence.

As described above, by preventing the contamination caused by the foreign bodies adhered to the surface of the wafer 1 as an effect of the dynamic control of the cleanliness environment, it becomes possible to perform an inspection with higher reliability.

In addition, as other effects, the following can be listed.

(1) The degree of the cleanliness is improved.

(2) The formation time of the air current flow can be shortened→Shortening of the throughput.

(3) An appropriate utilization of the cleanliness environment formation equipment is possible.

(4) No excessive equipment is required, because there is no waste of the supply air, exhaust blow.

(5) The whole size can be reduced, because the space to secure wasteful air current can be reduced.

(6) The cycle time of the periodical cleaning can be extended, because the long term stability of the degrees of the cleanliness can be secured.

(7) Appropriate components can be used and the component specifications more than necessary are not required.

Furthermore, in the future, it is possible to adapt the future requirement condition as below.

(1) It is possible to make the degrees of the cleanliness upper than the current one.

(2) It is possible to form the cleanliness environment at a time of the diameter up-sizing of the future wafer.

(3) It is possible to adapt the shortened throughput and the higher speed in the future.

### INDUSTRIAL APPLICABILITY

In the present invention, the feature has been to provide an air current control means for controlling the air current flow in the vicinity of the wafer which rotates in the high speed having a wafer surface inspection device as an object, however it is possible to apply to the substrate inspection for the hard disks, liquid crystal substrates or the like, except for the wafers.

Moreover, the present invention can be applied to the wafer inspection devices with a method for condensing the scattered light by using ellipsoid bodies, and can be also applied to the hard disks inspection devices for inspecting the defects of the hard disks.

In addition, the division numbers of the FFU and the exhaust unit are not limited to 4, and the number of the wind speed sensor is not limited to the embodiment, either. It is good enough if it is possible to suppress the disturbance of the air current by Ekman's spiral vortex flow, or Karman's vortex flow, or the like.

### EXPLANATION OF REFERENCES

1 wafer
2 optical system
3 FFU (divided into four)
4 rotation mechanism
5 horizontal direction movement mechanism
6 vertical direction movement mechanism
7 FFU (upper part)
8 louver
9 wafer chuck
11 exhaust unit
12 central exhaust mechanism
13 detection unit
14 wind speed sensor

1. An inspection device for inspecting a substrate, comprising:
a fan filter unit which is divided into a plurality of domains;
an exhaust unit which is divided into a plurality of domains for exhausting air from the fan filter unit; and
a transfer system which is disposed between the fan filter unit and the exhaust unit,
and controlling, depending on movement of the transfer system,
a flow amount in a partial domain of the fan filter unit; and
a flow amount in a partial domain of the exhaust unit.

2. The inspection device according to claim 1, further comprising a wind speed sensor; wherein
the fan filter unit and the exhaust unit vary the flow amount, depending on information from the wind speed sensor.

3. The inspection device according to claim 2, wherein the wind speed sensor is disposed at least in either one of a delivery position of an inspected object in the transfer system, or an inspection position.

4. The inspection device according to claim 1, further comprising a louver at least in either one of a backward part of the fan filter or a forward part of the exhaust unit.
